(19) United States
(12) Patent Application Publication
(10) Pub. No.: US 2010/0146052 A1
(43) Pub. Date: Jun. 10, 2010

(54) METHOD AND A SYSTEM FOR SETTING UP ENCOUNTERS BETWEEN PERSONS IN A TELECOMMUNICATIONS SYSTEM

(75) Inventors: Louis Pare, Paris (FR); Philippe Horville, Nanterre (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/663,043

(22) PCT Filed: Jun. 19, 2008
(86) PCT No.: PCT/FR08/51100

§ 371 Date: Feb. 10, 2010

(30) Foreign Application Priority Data
Jun. 22, 2007 (FR) 0755954

(51) Int. Cl. G06F 15/16; G06F 3/048

(52) U.S. Cl. 709/204; 715/757

(57) ABSTRACT

The invention relates to a method for establishing a communication between a first person (12₁) and at least a second person (12₂) in an environment (20) where said first and second persons (12₁, 12₂) are respectively connected via a first and a second communication terminal (11₁) (11₂) each connected to a communication network (30). According to the invention, the method comprises the step (504₁) of progressively exposing or masking on said second terminal (11₂) at least one graphical representation (32) of the real aspect of said first person.

The present invention relates to a method and to a system for setting up encounters between persons seeking to date via a synchronous telecommunications system taking the form of a virtual environment to which each person is connected via a communications terminal connected to a communications network.

The general field of the invention is more specifically that of “speed dating”, offering a method of setting up a series of short dates.

As is known in the art, speed dating is a dating method in which persons seeking compatible persons can meet face-to-face.

Speed dating is generally organized by establishments such as cafés, restaurants, bars, etc., usually to attract a “singles” clientele.

Although very fashionable, especially in large towns, speed dating as it exists at present has some drawbacks.

A first drawback is that it requires the persons to meet up at the same predetermined geographical location.

A second drawback, induced by the first, is linked to the fact that the physical persons able to participate in a speed-dating session are necessarily limited to persons geographically close to the chosen meeting place, which reduces the chance of them finding a kindred spirit.

To alleviate these drawbacks, virtual speed dating systems have appeared. They promote a wider range of encounters, at any time of day and with no geographical limitation, between persons who simultaneously share a speed-dating virtual environment to which each is connected via a communications terminal connected to a communications network.

During a virtual speed dating session, each physical person is represented by an avatar through which they can dialogue in a reserved virtual space with the avatar of another physical person they wish to encounter for a predetermined time.

Because they offer the possibility of meeting a greater number of persons, without having to travel and regardless of the geographical distance between them, such systems increase the chance of a single person encountering persons matching most closely their selection criteria. The only condition for these various persons is that they belong to the same virtual speed dating service or online environment.

A drawback of virtual speed dating systems lies in the impersonal nature of the encounter often experienced by the participants, because of the 2D or 3D virtual avatars used to represent them in the virtual speed dating environment.

Although an avatar can usually be personalized on screen, the image it gives very often suffers from a mismatch such that it is not very representative of the real physical appearance of the person it is deemed to represent, which spoils the natural aspect of the relationship initiated by the participants in a virtual speed dating session and sometimes even contributes to them having problems with objectively assessing the quality of the relationship at the end of the session.

To alleviate this drawback, some virtual speed dating systems prompt each participant at the end of a speed dating session to exchange a photograph or other form of real graphical representation of their physical person via the virtual speed dating environment.

However, the experience of the inventors and studies they have carried out indicate that disclosing to a second physical person the real image of a first physical person (and vice-versa) to whom they have been relating via interposed avatars only at the end of a virtual speed dating session between them is often badly received by them because there it is not a good match with the image that they have formed of each other and their personalities while relating and communicating via their respective avatars.

The present invention offers a solution that is free of the drawbacks referred to above.

The invention aims to solve the above drawbacks by proposing a method of progressively disclosing or masking, on the terminal of each of the persons relating in the context of a virtual speed dating session, a visual representation of the other person, on the fly during the session and as a function of the evolving communication between and respective impressions of the persons of each other.

The present invention is in fact a way of enabling each person to form a precise idea of the personality of the other person and their physical appearance progressively over the entire duration allowed for the virtual speed dating session, enabling each to choose objectively whether they wish to take the relationship further after said session.

To this end, the invention relates to a method of setting up an encounter between a first person and at least one second person in an environment to which said first and second persons are connected by respective first and second terminals each connected to a communications network.

According to the invention, such a method advantageously includes a step of progressively disclosing at least one graphical representation of a real likeness of the first person on said second terminal.

The proposed solution thus consists in establishing a link between the emotions and behavior of participants in a virtual speed dating session and the progressive disclosing of a graphical representation that is truly representative of the physical appearance of the other person.

Such automatic adaptation and the resulting progressive nature of the disclosure constitute a true innovation over prior art systems, the method and system of the invention further contributing to making the encounter between the persons more natural and comfortable for them, i.e. to making it closer to what happens in real life.

In a preferred implementation of the invention, said method further includes a step of progressively disclosing at least one graphical representation of a real likeness of the second person on the first terminal.

The physical persons can thus be mutually revealed during their encounter via a virtual environment, for example a virtual speed dating environment.

Said disclosure step advantageously takes account of the result of a step of monitoring communication between said first and second persons in said environment, said monitoring step being executed dynamically during a predetermined encounter duration.

In a preferred implementation of the invention, with said environment taking the form of a virtual environment in which said first and second persons are respectively represented by first and second avatars, said monitoring step is a step of detecting evolution in said virtual environment of the behavior of said first avatar with regard to said second avatar and/or of said second avatar with regard to said first avatar.

With said first and second terminals being connected to respective devices for storing gestures of said first and second physical persons with a view to their reproduction by said first and second avatars, said evolution of behavior is advantageously detected by recognizing a particular gesture associated with the first or second physical person and stored by said respective storage device.

In the event of positive evolution of said encounter at least one graphical transformation is preferably applied to disclose said graphical representation of a real image of said first person, respectively said second person, displayed on said second terminal, respectively said first terminal, and, in the event of negative evolution of said encounter, a graphical transformation is applied that is the opposite of the above-mentioned graphical transformation, to mask said graphical representation of a real image of said first person, respectively said second person, displayed on said second terminal, respectively said first terminal.

In one particular implementation of the invention, said graphical transformation uses a step of depixelization of said graphical representation.

Said graphical transformation and said opposite graphical transformation advantageously take account of information representing the time remaining before said predetermined time elapses.

The invention also provides a system for setting up an encounter between a first person and at least one second person in an environment to which said first and second persons are respectively connected by first and second terminals each connected to a communications network.

According to the invention, said system advantageously includes:
means for setting up an encounter between said first and second persons via said environment;
means for progressively disclosing on said second terminal at least one graphical representation of a real likeness of the first person.

Such a system preferably further includes means for progressively disclosing on said first terminal at least one graphical representation of a real likeness of the second person.

Said progressive disclosure means preferably take account of an input parameter consisting of information reflecting the evolution of said encounter between said first and second persons in said environment, said information being produced by dynamic monitoring means activated for a predetermined encounter duration.

Said environment advantageously taking the form of a virtual environment in which said first and second persons are respectively represented by first and second avatars, said monitoring means detect evolution in said virtual environment of the behavior of said first avatar with regard to said second avatar and/or of said second avatar with regard to said first avatar.

In one preferred embodiment of the invention, said first and second terminals being connected to devices for storing gestures of said first and second physical persons, respectively, with a view to their reproduction by said first and second avatars, said system advantageously includes detection means adapted to recognize at least one particular gesture associated with the first or second physical person, respectively, and reflecting evolution of their behavior.

Each of said first and second terminals preferably includes means for indicating an instantaneous mood operable by said first and second persons, respectively, said mood of each of said first and second persons being taken into account by said monitoring means to detect evolution of said encounter.

The invention also provides a computer program product downloadable from a communications network and/or stored by an information medium readable by a computer and/or executable by a microprocessor.

Such a computer program product advantageously includes code instructions for executing the above encounter method when it is executed on a computer.

Other features and advantages of the present invention emerge from the description given below, with reference to the appended drawings, which illustrate one non-limiting embodiment of the invention. In the figures:

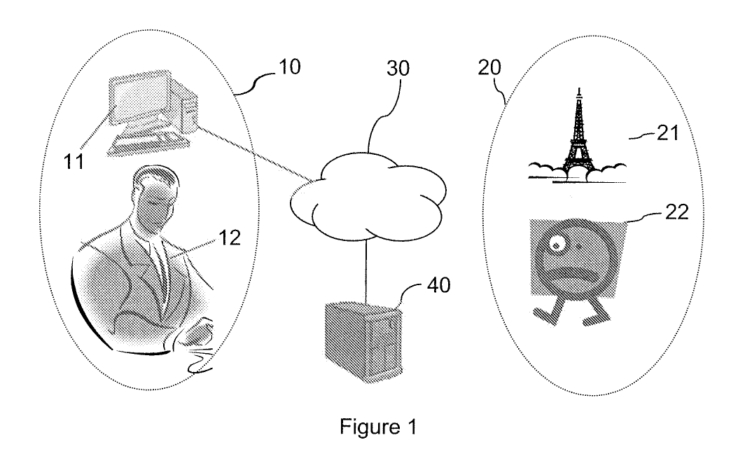

FIG. 1 is a diagrammatic view of a system of the invention;

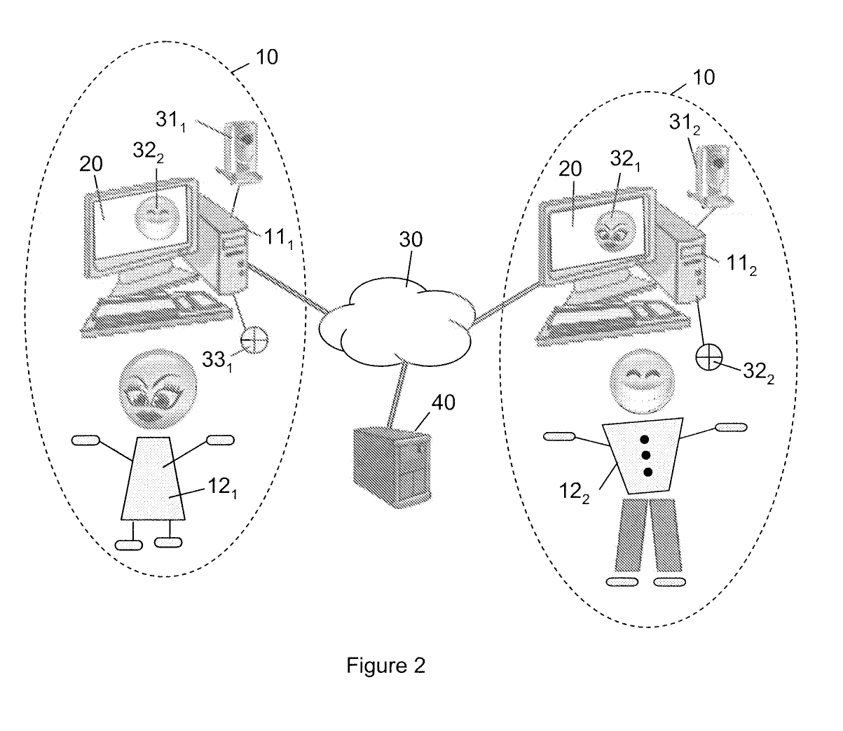

FIG. 2 represents a system conforming to a preferred embodiment of the invention for setting up encounters between persons; and

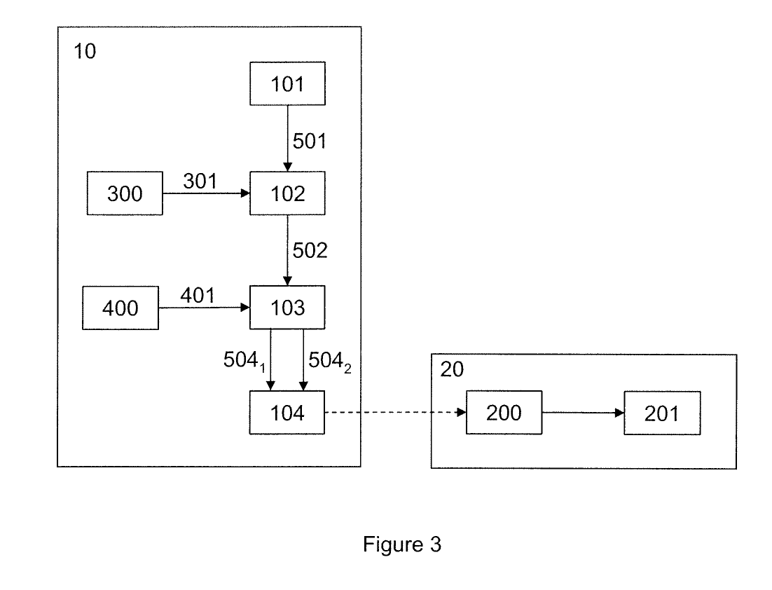

FIG. 3 represents in flowchart form the principal steps of a method conforming to a preferred embodiment of the invention for setting up encounters between persons.

As shown in FIG. 1, a real world 10 can be made up of users 12 who are usually geographically remote and each equipped with a system 11 for total immersion in a virtual environment (or world) 20 made up of avatars 22 in which each avatar 22 of the real world 10 represents one of the real world users 12.

In the framework of the present invention, a total immersion system 11 can take the form of a computer terminal or any other communications terminal connected via a communications network 30 to a server hosting the virtual world.

A server 40 has the function of monitoring, coordinating, controlling, broadcasting and even storing events in the virtual world triggered by the various avatars in the virtual world.

Thus a user 12 in the real world 10 is represented in a virtual world 20 by an avatar 22.

A user 12 can therefore “drive” the behavior of their avatar in real time via their terminal 11 to cause it to move, move around and interact with other avatars of the virtual world. In the background, the video capture device connected to said terminal simultaneously copies to their avatar in the virtual world the gestures and expressions, more generally the behavior, of the user being filmed.

By virtue of the use of such a video capture device, the gestures and more generally the behavior of an avatar can be monitored and analyzed continuously, enabling in particular monitoring and interpretation of the behavior of each avatar on the basis of predefined expressions or gestures detected in the avatar.

This proves particularly beneficial in the framework of the present invention, which relates to setting up encounters, preferably between two physical persons who are “single”, by way of interposed avatars in a virtual environment suitable for speed dating type encounters.

The solution proposed consists in setting up a link between the emotions of the user, as reflected in their behavior, for example, and the progressive disclosing of a graphical representation of the other person.

The participants find the impression of presence in the virtual world more like a game and more comfortable, which tends to render the encounter between the participants in a virtual speed dating session more natural and more similar to what would happen in the real world on the occasion of a face-to-face encounter at the same geographical location.

As shown in FIG. 2, each user 12₁, 12₂ in the real world 10 has a respective total immersion system 11₁, 11₂, for example a communications terminal, for driving an avatar representing them in a shared virtual world 20, for example a virtual world 20 suitable for speed dating type encounters between the physical persons 12₁, 12₂.

Respective video capture devices 31₁, 31₂ connected to the terminals 11₁, 11₂ capture a view of each of the users 12₁ and 12₂ to copy their behaviors and attitudes to their respective associated avatar in the shared speed dating virtual environment 20.

Sequences captured in this way are analyzed by a server 40 for managing and monitoring what happens in said virtual environment 20 so that predefined gestures or expressions, for example reflecting a mood of a participant in a virtual speed dating session, can be recognized.

Some of these expressions, when detected and interpreted, depending on whether they reflect positive or negative evolution of the encounter between the persons 12₁, 12₂, imply either a speeding up or a slowing down of the disclosing of the graphical representation 32₁, 32₂ of each of the participants 32₁, 32₂ in a speed dating session on the screen of the terminal 11₁, 11₂ of the other participant, to which terminal they are connected by the system of the invention.

If no pertinent expression is detected, the graphical representation is disclosed progressively at a constant rate over the whole of the predetermined duration of a speed dating session.

In the method of the invention, the display of the graphical representation 32₁, 32₂ of at least one of the two participants 12₁, 12₂ in a virtual speed dating session on the terminal 11₁, 11₂ of the other participant can be progressively masked or covered up, depending on whether the encounter between the two participants evolves positively or negatively over the predetermined duration assigned to the virtual speed dating session.

It is obvious that the invention does not apply only to virtual environments suitable for an encounter of the speed dating type, for example between singles, but can apply to any (2D or 3D) virtual environment using functions for progressively disclosing a graphical representation of a person or a specific object taking account of at least certain categories of parameters, such as emotions associated with a physical person. The invention can in particular be applied effectively to any other type of on-line application service, for example online recruiting.

The invention is implemented using the stream from the video capture device 31₁, 31₂, for example a web cam, the function of which is to copy to their avatar 2D or 3D representing them in said virtual environment 20 gestures and/or expressions and/or attitudes of a physical person 12₁, 12₂ connected to the virtual speed dating environment by means of a total immersion device in the form of their communications terminal 11₁, 11₂.

The user's emotional attitudes (behavior, gestures, bodily attitudes, facial expressions, etc.) are thus detected either directly by analyzing the video stream or by interpreting them on their avatar, to which they have previously been copied.

Recognition of characteristics associated with emotions, for example a movement of the corners of the lips away from each other in association with a closed mouth could be interpreted as a smile, which would be represent the enjoyment of the physical person as represented by their avatar in the virtual speed dating environment. This enjoyment reflecting positive evolution of the encounter between two physical persons via their interposed avatars in the virtual speed dating environment 20 then constitutes an event triggering a modification of the graphical representation 32₂, for example faster or slower depixelization of the display of a photo 32₂ of the second person 12₂ (the one who is smiling) on the terminal 11₁ of the first person 12₁ with whom an encounter has been set up.

It is obvious that if the converse situation in which one of the participating persons becomes angry were to be detected, this would lead to faster or slower masking of the display of the image of the angry person on the terminal of the other person with whom they are communicating via the virtual speed dating environment.

To be more precise, variable pixelization is obtained by applying convolution to the pixels constituting the image and applying the result of this convolution to the image of a first person (or more generally to a graphical representation of a person) displayed on the terminal of the second person participating in the virtual speed dating session.

The convolution parameters vary as a function of the emotional parameter detected. For example, increasing the size of the convolution matrix increases a soft focus effect.

To give a simple, illustrative and non-limiting example, the emotional parameters detected could be of the type belonging to the following group or a combination thereof;
nodding the head;
shaking the head;
an interrogation movement;
a movement of astonishment, involving inclination of the head, moving the face of said second person toward or away from the lens of said video capture device;
eye movements such as winking;
movement of the eyebrows;
movement of the mouth;
movement of the nose.

In an expanded embodiment shown in FIG. 2, the system of the invention for setting up an encounter further includes:
an automatic or manual control 33₂ for interrupting/resuming/accelerating/slowing modification of the graphical representation 32₁ of the image of a first person 12₁ viewed by a second person 12₂ during a virtual speed dating session, said control 32₂ taking account of the elapsed time of the speed dating session and at least one parameter reflecting the mood of said first or second person 12₁ or 12₂;
an automatic or manual control 33₁ for interrupting/resuming/accelerating/slowing modification of the graphical representation 32₁ of the image of a first person 12₁ seen by a second person 12₂ during a virtual speed dating session, said control 32₁ taking account of the elapsed time of the speed dating session and at least one parameter reflecting the mood of said first or second person 12₁ or 12₂.

The translation of any such mood change could be effected by automatic or manual movement of a mood cursor 33₁, 33₂ connected to the respective terminal 11₁ or 11₂ so that each of the physical persons 12₁ or 12₂ can control and/or modify according to their own mood the instantaneous mood that they would wish to impart to their avatar in the virtual speed dating environment 20.

As shown in FIG. 3, in a real world 10, a device 101 for video stream capture 501 transmits images and sounds of the user continuously.

A container 300, for example a file or a database, contains conditions 301 to be complied with to deduce an emotion. For example, a moving apart of the lip corners and the fact that the teeth can be seen in the image could be interpreted as the occurrence of a smile indicating that the person is feeling happy.

The processing method 102 analyzes the video stream 501 and determines the appearance of emotion using rules 301 from the container 300. An appearance 502 of emotion is sent to the method 103 when it is detected.

A container 400, for example a file or a database, contains n-tuplets 401 whose first element is an emotion and whose second element is a modification of its graphical representation in the virtual world 20. For example, [smile, acceleration of the disclosing of a graphical representation] or [anger, slowing of the disclosing of a graphical representation].
The processing method 103 decides which action 504₁ (second element) is to be sent to a control interface 104 by searching for the emotion 502 in the first element of the available n-tuplets 401.

The interface 104 controls the disclosure of the graphical representation of the user to the other party, for example via more or less pixelization in their photograph. If the method 103 sends no command 504₁ or 504₂, the interface 104 causes progressive disclosure on the terminal of the other party of the graphical representation of the user as a function of the elapsed time.

Each emotion that corresponds to the first element of an n-tuplet 401 stored in the container 400 triggers in the virtual world a modification 504₁ or 504₂ of its graphical representation on the interface 104 corresponding to the second element of the n-tuplet 401. For example, a smile causes acceleration of the disclosure of its graphical representation by reducing the pixelization, whereas a movement indicating anger slows the disclosure of the graphical representation of the angry person displayed on the terminal of the other person with whom they are communicating.

It is of course possible to capture the mood of the persons between whom the encounter has been set up directly from the avatars representing them in the virtual speed dating environment 20 by means of the server 40 monitoring and managing said virtual environment.

1. A method of setting up an encounter between a first person and at least one second person in an environment to which said first and second persons are connected by respective first and second terminals each connected to a communications network, said method comprising a step of progressively disclosing or masking at least one graphical representation of a real likeness of said first person on said second terminal.

2. The method according to claim 1 further comprising a step of progressively disclosing or masking at least one graphical representation of a real likeness of said second person on said first terminal.

3. The method according to claim 1, wherein said disclosure step takes account of information reflecting evolution of said encounter between said first person and said second person in said environment, said information being produced during a dynamic monitoring step activated for a predetermined encounter duration.

4. The method according to claim 1, wherein said environment is a virtual environment in which said first and second persons are respectively represented by first and second avatars, said monitoring step is a step of detecting evolution in said virtual environment of the behavior of said first avatar with regard to said second avatar and/or of said second avatar with regard to said first avatar, said detection step taking account of information from video capture devices of each of the users respectively connected to the terminals.

5. The method according to claim 4, wherein said first and second terminals are connected to respective devices for storing gestures of said first and second physical persons with a view to their reproduction by said first and second avatars, said evolution of behavior is detected by recognizing a particular gesture associated with the first or second physical person and stored by said respective storage devices.

6. The method according to claim 1, wherein in the event of positive evolution of said encounter at least one graphic transformation is applied to disclose said graphical representation of a real image of said first person, respectively said second person, displayed on said second terminal, respectively said first terminal, and in that in the event of negative evolution of said encounter a graphical transformation is applied that is the opposite of said graphical transformation to mask said graphical representation of a real image of said first person, respectively said second person, displayed on said second terminal, respectively said first terminal.

7. The method according to claim 6, wherein said graphical transformation uses a step of depixelization of said graphical representation.

8. The method according to claim 6, wherein said graphical transformation and said opposite graphical transformation take account of information reflecting the time remaining before said predetermined duration elapses.

9. A system for setting up an encounter between a first person and at least one second person in an environment to which said first and second persons are respectively connected by first and second terminals each connected to a communications network, said system comprising:
means for setting up an encounter between said first and second persons via said environment;
means for progressively disclosing or masking on said second terminal at least one graphical representation of a real likeness of said first person.

10. The system according to claim 9, comprising means for progressively disclosing or masking on said first terminal at least one graphical representation of a real likeness of said second person.

11. The system according to claim 9, wherein said progressive disclosure means take account of an input parameter consisting of information reflecting evolution of said encounter between said first and second persons in said environment, said information being produced by dynamic monitoring means activated for a predetermined encounter duration, said monitoring means being adapted to recognize and interpret characteristics associated with the emotions of said first and second persons.

12. The system according to claim 9, wherein said environment takes the form of a virtual environment in which said first and second persons are respectively represented by first and second avatars, said monitoring means detect evolution in said virtual environment of the behavior of said first avatar with regard to said second avatar and/or of said second avatar with regard to said first avatar, said detection means taking account of information from video capture devices of each of the users and respectively connected to the terminals.

13. The system according to claim 12, wherein, said first and second terminals are connected to devices for storing gestures of said first and second physical persons, respectively, with a view to their reproduction by said first and second avatars, it includes detection means adapted to recognize at least one particular gesture associated with the first or second physical person, respectively, and reflecting an evolution of behavior.

14. The system according to claim 11, wherein each of said first and second terminals includes means for indicating an instantaneous mood operable by said first and second persons, respectively, said mood of each of said first and second persons being taken into account by said monitoring means to detect evolution of said encounter.

15. A computer program product downloadable from a communications network and/or stored by an information medium readable by a computer and/or executable by a microprocessor, said computer program comprising code instructions for executing a method according to claim 1 of setting up an encounter when it is executed on a computer.
